(19) United States
(12) Patent Application Publication
(10) Pub. No.: US 2021/0102011 A1
(43) Pub. Date: Apr. 8, 2021

(54) Phthalate Free polypropylene composition having high flexural modulus with High melt flow rate

(71) Applicant: Formosa Plastics Corporation, USA, Livingston, NJ (US)

(72) Inventors: Gapgoung Kong, Sugarland, TX (US); Lei Zhang, Port Lavaca, TX (US); Chih-Jian Chen, Port Lavaca, TX (US); Guangxue Xu, Port Lavaca, TX (US)

(21) Appl. No.: 16/591,320

(22) Filed: Oct. 2, 2019

(51) Int. Cl. C08F 110/06

(52) U.S. Cl. CPC C08F 110/06

(57) ABSTRACT

The present invention relates to a phthalate free polypropylene homo-polymer having a flexural modulus higher than 290 kpsi with a melt flow rate is greater than 80 g/10 min. The polymer is produced in the presence of phthalate free Ziegler-Natta catalyst containing internal donors comprising at least one of a di-ether and modifier compound. The present invention also includes a process for making the polypropylene homo-polymer according to the present invention.

### BACKGROUND

This invention relates to phthalate-free polypropylene homo-polymer and compositions containing polypropylene homo-polymer. More specifically, the present invention relates to phthalate free polypropylene homo-polymers that have high flexural modulus and a high melt flow rate.

While there has been enormous need for polypropylene having high flexural modulus and high melt flow rate, preparation of polypropylene composition having high flexural modulus and high melt flow rate has been a challenge, requiring a highly stereo-specific crystalline polymer structure with low xylene soluble. Traditionally, di-ether catalyst is known to produce polypropylene having high melt flow rate, with the drawback of relatively low flexural modulus as compared to phthalate catalysts. Recently, there has been attempts to produce high melt flow rate polypropylene having high stereo-specificity by combining di-ether donors and phthalate donors in the catalyst composition. For example, U.S. Pat. No. 7,465,776 B2 describes a process for producing a high melt flow rate and high crystalline polypropylene homo-polymer by employing catalyst containing both di-ether and phthalate donors to produce a polypropylene composition having a melt flow rate of 60 dg/min to 300 dg/min with xylene soluble less than 2 wt %. U.S. Pat. No. 7,022,796 B2 describes a polypropylene composition having a melt flow rate of 300 to 400 g/10 min with xylene soluble less than 3.5 wt %, produced by employing RK-100 that contains both di-ether and a phthalate donor. But due to recent health concerns and regulations, the requirements for phthalate free polypropylene has been growing. There continues to be a need for phthalate free polypropylene having both high melt flow rate and highly crystalline structure.

Recently, U.S. Pat. No. 10,273,319 B2 teaches phthalate free catalyst components including spherical MgCl2.xROH and di-ether donor producing polypropylene homo-polymer with xylene soluble greater than 2.0 wt %, or less than 2.0 wt % depending on the molar ratio of di-ether to Mg. But U.S. Pat. No. 10,273,319 B2 does not describe polypropylene homo-polymer having both high melt flow rate and high crystalline structure. In fact, the examples demonstrate that when melt flow rate is high, xylene soluble goes up to 9.1 wt %, which indicates that it is not a highly crystalline polymer.

U.S. Pat. No. 7,491,781 teaches the use of an internal electron donor in a propylene polymerization catalyst component which does not contain a phthalate derivative. However the resultant propylene polymerization catalyst produced polypropylene with lower isotacticity than that of a catalyst containing a phthalate derivative.

U.S Patent App. No. 2016/0326277 A1 teaches the combination of carbonate ether compound with 1,3-diether internal donors in propylene polymerization catalyst components to improve the block ratio of ICP polymerization and molecular weight distribution, however this does not describe the polypropylene homo-polymer having both high melt flow rate and high crystalline structure.

Another method of achieving a high melt flow rate in a polymer is through treatment with a vis-breaking agent to increase melt flow rate, but this method produces higher xylene soluble polymers and negatively affects polymer properties such as flexural modulus.

### SUMMARY OF THE INVENTION

The present invention provides a phthalate free polypropylene homo-polymer produced in the presence of phthalate free Ziegler-Natta catalyst containing internal donors comprising at least one of a di-ether, modifier compound (modifier) and an external donor, The polypropylene homo-polymer according to a preferred embodiment of present invention has a flexural modulus greater than 290 ksp while having a melt flow rate greater than 80 dg/min. In preferred embodiments, the melt flow rate is greater than 100 dg/min while having flexural modulus greater than 300 kpsi. The present invention also includes a process for making the polypropylene homo-polymer according to the novel phthalate free Ziegler-Natta catalyst.

### DESCRIPTION OF THE INVENTION

The present invention provides a composition and process for producing phthalate free, highly crystalline, high flexural modulus polypropylene homo-polymers with a high melt flow rate. When formulated with a nucleating agent, the polypropylene homo-polymers according to the present invention exhibit a flexural modulus of at least 290 kpsi, a tensile strength at break of at least 5000 psi, and provides a good base material for compounding with rubber, elastomer, fillers, and other additives.

The polypropylene homo-polymers according to the present invention have melt flow rates of at least 80 dg/min, as measured using test method ASTM-D1238. The melt flow rates of the polypropylene homo-polymers according to the current invention preferably range from 80 to 300 dg/min.

The crystallinity of the polypropylene homo-polymers according to the present invention is measured using several properties of the polymers. The content of xylene soluble in the polymers is preferably less than 2 wt % as measured using test method ASTM-D5492, and more preferably less than 1.5 wt %. The overall crystallinity of the polymers according to the current invention may be measured using either differential scanning calorimetry (DSC) or x-ray diffraction (XRD).

When formulated with a nucleating agent, the polypropylene homo-polymers according to the present invention preferably exhibit a flexural modulus of greater than about 290 kpsi, as measured using test method ASTM D790. The tensile strength at break the nucleated homo-polymer is preferably above 5,000 psi.

The phthalate free homo-polymer of the present invention is a good base material for compounding with rubber, elastomer, fillers and other additives. The homo-polymer according to the present invention is also capable of being carried forward into a subsequent polymerization reactor to produce copolymers with a co-monomer selected from the group consisting of C₂-C₆ alkenes other than propylene. The polypropylene homo-polymers having a high melt flow rate according to the present invention are produced in-reactor, without the necessity of vis-breaking.

The phthalate free polypropylene homo-polymers of the present invention can be produced using a specific phthalate free Zeigler-Natta (ZN) catalyst containing internal donor components comprising at least one of a di-ether, and modifier compounds (modifiers), and an external donor, wherein the modifier compounds are selected from the group consisting of oxalic acid amide, alkylamide, urea, carbonate compounds, or their derivatives, such as described in U.S. Pat. Nos. 9,593,184 B2; 9,777,084 B2; 9,815,920 B2; and 10,124,324 B2, which are incorporated by reference herein in their entireties. However, the activity of di-ether catalysts mentioned above decays quickly, and there is a known drawback in the commercial application of such catalysts for the stable and high volume production of high MFR polypropylene.

In a preferred embodiment of present invention, the polypropylene homo-polymers are produced using a catalyst system comprising a phthalate free Zeigler-Natta (ZN) catalyst component, alkylaluminum, and an external electron donor. The phthalate free Zeigler-Natta(ZN) catalyst components are produced by contacting titanium chloride with magnesium ethoxide in the presence of internal donors comprising 1,3-diether, carbonate ether, and urea compounds. Further, in a preferred embodiment of present invention, commercial production of the polypropylene homo-polymer having high MFR can be operated with a stable and highly productive condition using the phthalate free Zeigler-Natta (ZN) catalyst

Examples of 1,3-diethers include: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 1,1-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7-tetrahydroindene, 1,1-bis(methoxymethyl)-7-methylindene, 1,1-bis(methoxymethyl)-1H-benz[e]indene, 1,1-bis(methoxymethyl)-1H-2-methylbenz[e]indene, 9,9-bis(methoxymethyl)fluorene, 9,9-bis(methoxymethyl)-2,3,6,7-tetramethylfluorene, 9,9-bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7-diisopropylfluorene, 9,9-bis(methoxymethyl)-1,8-dichlorofluorene, 9,9-bis(methoxymethyl)-2,7-dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, and 9,9-bis(methoxymethyl)-4-tert-butylfluorene.

Examples of carbonate ether are, but not limited to (2-methoxyethyl) methyl carbonate, (2-ethoxyethyl) methyl carbonate, (2-propoxyethyl) methyl carbonate, (2-butoxyethyl) methyl carbonate, (2-(2-ethoxyethyloxy)ethyl) methyl carbonate, (2-benzyloxyethyl) methyl carbonate, (2-methoxypropyl) methyl carbonate, (2-ethoxypropyl) methyl carbonate, (2-methyl-2-methoxybutyl) methyl carbonate, (2-methyl-2-ethoxybutyl) methyl carbonate, (2-methyl-2-methoxypentyl) methyl carbonate, (2-methyl-2-ethoxypentyl) methyl carbonate, (1-phenyl-2-methoxypropyl) methyl carbonate, (2-methoxyethyl) ethyl carbonate, (2-ethoxyethyl) ethyl carbonate

Examples of urea compounds are but not limited to N,N,N′,N′-tetramethylurea, N,N,N′,N′-tetraethylurea, N,N,N′,N′-tetrapropylurea, N,N,N′,N′-tetrabutylurea, N,N,N′,N′-tetrapentylurea, N,N,N′,N′-tetrahexylurea, N,N,N′,N′-tetra(cyclopropyl)urea, N,N,N′,N′-tetra(cyclohexyl)urea, N,N,N′,N′-tetraphenylurea, bis(butylene)urea, bis(pentylene)urea, N,N′-dimethylethyleneurea, N,N′-dimethylpropyleneurea, N,N′-dimethyl(2-(methylaza)propylene)urea and N,N′-dimethyl(3-(methylaza)pentylene)urea. n-amyltriphenylurea, n-hexyltriphenylurea, n-octyltriphenylurea, n-decyltriphenylurea, n-octadecyltriphenylurea, n-butyltritolylurea, n-butyltrinaphthylurea; n-hexyltrimethylurea, n-hexyltriethylurea, noctyltrimethylurea, dihexyldimethylurea, dihexyldiethylurea, trihexylmethylurea, tetrahexylurea; n-butyltricyclohexylurea, t-butyltriphenylurea; 1,1-bis(p-biphenyl)-3-methyl-3-n-octadecylurea; 1,1-di-n-octadecyl-3-t-butyl-3-phenylurea; 1-p-biphenyl-1-methyl-3-noctadecyl 3 phenylurea; 1-methyl-1-n-octadecyl-3 p-biphenyl-3-o-tolylurea; m-terphenyl-tri-t-butylurea, 1,3-dimethyl-2-imidazolidinone, 1,3-diethyl-2-imidazolidinone, 1,3-dipropyl-2-imidazolidinone, 1,3-dibutyl-2-imidazolidinone, 1,3-dimethyl-3,4,5,6-tetrahydro-2-pyrimidinone, N,N-dimethyl-N,N-diphenylurea,

Examples of external donors that enable the ZN catalyst to produce high melt flow rate polypropylene homo-polymers having a high flexural modulus and highly crystallinity include, without limitation: Cyclohexylmethyldimethoxysilane; cyclohexylethyldimethoxysilane; isobutylisopropyldimethoxysilane; diphenyldimethoxysilane; isobutylisopropyldimethoxysilane; phenyltriethoxysilane; 3,3,3-trifluoropropylmethyldimethoxysilane; diisopropyldimethoxysilane; octylmethyldimethoxysilane; isobutyltrimethoxysilane; isobutyltriethoxysilane; n-propyltrimethoxysilane; di-t-butyldimethoxysilane; cyclopentyl 1,1-dimethyl-2,2-dimethylethyldimethoxysilane; and diamino silanes such as (R₂N)₂Si(OCH₃)₂, (R₂N)₂Si(OCH₂CH₃)₂ and (piperidinyl)₂Si(OCH₃)₂. The preferred molar ratio of the external donor to titanium in the ZN catalyst is about 5 to about 30, preferably about 8 to about 15, and most preferably about 10.

According to the present invention, the phthalate free ZN catalyst is used in combination with an organoaluminum compound as a co-catalyst to produce high flexural modulus, high melt flow rate polypropylene homo-polymers. Desirably the co-catalyst is an aluminum alkyl having the formula AlR₃, where R is an alkyl having 1 to 8 carbon atoms, with R being the same or different. Examples of suitable aluminum alkyls are trimethyl aluminum (TMA), triethyl aluminum (TEAL) and triisobutyl aluminum (TIBAL). The desired aluminum alkyl is TEAL.

### Examples

TFC-1 catalyst, a Zeigler Natta Catalyst component (A) employing internal donors comprising 1,3-diether, carbonate ether and urea compounds as described above were produced via toll production in a commercial scale reactor for continuous gas phase polymerization The catalyst composition analysis showed a Ti % of 1-5 wt %, a diether % of 1-15 wt %, a carbonate % of 1-15 wt % and a urea % of 0.5-10 wt %.

Phthalate free polypropylene homo-polymer according to the present invention were prepared in a continuous gas phase polymerization process in the presence of TFC-1 catalyst containing components comprising at least one of diether and urea modifier compounds. The conditions for each polymerization and the properties of the resulting polymers are shown in Table 1. Nucleated pellets were produced in a continuous polymerization process and polymer properties and physical properties are summarized in Table 1. As a comparison with the present invention, the results from a catalyst containing phthalate derivatives are listed.

As shown in Table 1 below, polypropylene homopolymers produced according to the present invention demonstrate high flexural modulus of 293˜309 kpsi, with high melt flow rate (114˜214 g/10 min). The tensile strength at break is above 5000 psi, specifically 5149˜5820 psi. By comparison, the ZN catalyst containing a phthalate internal donor (phthalate catalyst) produced polypropylene homopolymers having much lower melt flow rate due to lower hydrogen response, and lower flexural modulus, as well as low tensile strength.

TABLE 1
Continuous Gas Phase polymerization results

| | Phthalate | | | | | |
|---|---|---|---|---|---|---|
| | catalyst | TFC-1 catalyst | | | | |
| Temp(° C.) | 80 | 80 | 80 | 80 | 80 | 80 |
| Yield | 37,000 | 34,000 | 34,000 | 35,000 | 35.000 | 35.000 |
| (gPP/gcat) | | | | | | |
| Si/Ti | 10 | 10 | 10 | 10 | 10 | 10 |
| (mol/mol) | | | | | | |
| Silane | diisobutyl- | | | Diisopropyl- | | |
| donor | dimethoxysilane | | | dimethoxysilane | | |
| Tm (° C.) | 161 | 165 | 165 | 165 | 164 | 165 |
| by DSC | | | | | | |
| Tc (° C.) | 119 | 134 | 135 | 134 | 132 | 133 |
| by DSC | | | | | | |
| MFR | 34 | 114 | 214 | 123 | 144 | 134 |
| (g/10 min) | | | | | | |
| % XS | 1.3 | 1.6 | 2.3 | 1.7 | — | 2.3 |
| Polymer | | | | | | |
| properties | | | | | | |
| Tensile | 2387 | 5773 | 5149 | 5820 | 5308 | 5625 |
| strength | | | | | | |
| @ break | | | | | | |
| (psi) | | | | | | |
| Flexural | 211 | 293 | 294 | 309 | 298 | 297 |
| modulus | | | | | | |
| (Kpsi) | | | | | | |

What is claimed is:

1. A polymer composition, comprising:
a phthalate free polypropylene homo polymer produced in a polymerization process in the presence of a catalyst system comprising one or more phthalate free Zeigler-Natta catalyst components, alkylaluminum, and an external electron donor,
wherein the polypropylene homopolymer has a flexural modulus of greater than about 290 kpsi, a tensile yield stress of greater than about 5000 psi, and a melt flow rate greater than about 80 g/10 min and less than about 300 g/10 min.

2. The polymer composition of claim 1, wherein the one or more phthalate free Zeigler-Natta catalyst components are produced by contacting titanium chloride with magnesium compounds in the presence of internal donors selected from 1,3-diether, urea, and carbonate ether compounds.

3. The polymer composition of claim 1, wherein the phthalate free polypropylene homo-polymer is the matrix of a compounding or reactor-grade copolymer.

4. The polymer composition of claim 1, wherein the phthalate free polypropylene homo-polymer is produced in a continuous gas phase process.

5. The polymer composition of claim 2, wherein at least one of the internal donors is selected from 1,3-diether compounds.

6. The polymer composition of claim 2, wherein at least one of the internal donors is selected from carbonate ether compounds.

7. The polymer composition of claim 2, wherein at least one of the internal donors is selected from urea compounds.

8. The polymer composition of claim 1, wherein the phthalate free polypropylene homopolymer has a melt flow rate greater than 110 g/10 min.

9. The polymer composition of claim 1, wherein the phthalate free polypropylene homopolymer has a melt flow rate greater than 140 g/10 min.

10. The polymer composition of claim 1, wherein the phthalate free polypropylene homopolymer has a melt flow rate greater than 200 g/10 min.

11. The polymer composition of claim 1, wherein the phthalate free polypropylene homopolymer has a flexural modulus of greater than about 300 kpsi, a tensile yield stress of greater than about 5800 psi, and a melt flow rate greater than 120 g/10 min.
